(19) United States
(12) Patent Application Publication
(10) Pub. No.: US 2003/0122811 A1
(43) Pub. Date: Jul. 3, 2003

(54) Handheld electronic device with selections for power on/off screens and the implementation method

(76) Inventor: Chia-Ming Hu, Kaohsiung (TW)

Correspondence Address: MARTINE & PENILLA, LLP, 710 LAKEWAY DRIVE, SUITE 170, SUNNYVALE, CA, 94085, US

(21) Appl. No.: 10/147,957

(22) Filed: May 15, 2002

(30) Foreign Application Priority Data
Dec. 31, 2001 (TW) 90133405

(51) Int. Cl. G09G 5/00

(52) U.S. Cl. 345/211

(57) ABSTRACT

A handheld electronic device providing selections for power on/off screens, which includes a display device, a non-default code storage device and a microprocessor. The microprocessor can be switched between a sleeping mode and an operating mode. When the microprocessor is in the sleeping mode, the non-default code storage device does not lose data stored therein. The non-default code storage device stores at least one screen data, and when the microprocessor is switched from the sleeping mode to the operating mode, the handheld electronic device reads the screen data from the non-default code storage device according to a default value, and displays the screen data onto the display device. This invention also discloses a method, which implements the selections for power on/off screens in the handheld electronic device.

### DESCRIPTION OF THE INVENTION

1. Field of the Invention

This invention relates to a handheld electronic device and, more particularly, to a handheld electronic device that provides selections for power on/off screens, and the implementation method.

2. Description of the Related Art

Along with the progress in semiconductor technology, highly integrated circuits have been produced, which makes electronic devices getting smaller in size. All sorts of small handheld electronic devices have been designed in order to satisfying users needs.

Referring to FIG. 1, using a personal digital assistant (PDA) 1 as an example, in conventional technique, the PDA 1 includes a read only memory (ROM) 11, a random access memory (RAM) 12, a microprocessor 13 and a display device 14. The ROM 11 is a default code storage device, which stores an operating system 111 for the PDA 1 and a preset screen data 112. The RAM 12 is a non-default code storage device, which stores the data needed when the operating system 111 is executing, or some programs downloaded by the user. The microprocessor 13 can be signally connected to the RAM 12 via a data address line, in order to access directly all data stored in the RAM 12, or through a memory controller to access data stored in the RAM 12.

When PDA 1 is powered on or reset, the operating system 111 firstly loads the pre-set screen data 112 to the corresponding video memory (not shown) of the display device 14 as the ‘power on/off screen’. At the same time of displaying the power on/off screen, the PDA 1 can carry out tasks such as system initialization, hardware resources searching, or data loading. After the forementioned tasks are completed, the operating system 111 then entered into a screen of user interface, ready to receive commands from the user.

To satisfy the users need of personalization, a conventional PDA 1 already has the functions allowing the user to set the power on/off screen. Referring to FIG. 2, in the conventional PDA 1, ROM 11 may use a flash memory and reserve a designated storage space 113 as the storage space for power on/off screen data. Users may edit the displaying data in the PDA 1, or download a displaying data from Internet, and save the new displaying data in the forementioned designated storage space. After being successfully stored, user may set this new displaying data as the power on/off screen data. If the forementioned designated storage space stores more than two screen data, the user may set one of the screen data as the power on/off screen data.

Nonetheless, in a handheld electronic device, because the location for ROM data storage must be pre-configured in order for the operating system to access, the size for the designated storage space on ROM for storing power on/off screen data is fixed, and usually is not very big. In other words, not too many power on/off screen data can be stored.

Furthermore, even if the space is not entirely used, the designated storage space is configured for storing power on/off screen data and cannot be used to store any other data. This reduces the flexibility of memory usage, and is a waste in memory usage.

### SUMMARY OF THE INVENTION

In view of the above-mentioned problems, one object of this invention is to provide a handheld electronic device with options for power on/off screens and the method to implement this. Unless the memory of the handheld electronic device has been used up, it does not limit the count of the power on/off screen data it can save.

Another object of this invention is to provide a handheld electronic device with options for power on/off screens and the method to implement this, which is more flexible in the memory usage.

In order to achieve the above objects, according to this invention, the handheld electronic device with options for power on/off screens includes a display device, a non-default code storage device and a microprocessor. The microprocessor can be switched between a sleeping mode and an operating mode. When the microprocessor is in the sleeping mode, the non-default code storage device does not lose data stored therein. The non-default code storage device can store data for at least one screen and when the microprocessor is switched from the sleeping mode to the operating mode, the handheld electronic device will, according to a default value, retrieve screen data from the non-default code storage device and displays the screen data onto the display device.

The above-mentioned non-default code storage device may be a random access memory (RAM). A default value may be stored in the RAM, or stored in the read only memory (ROM) of the handheld electronic device.

The above-mentioned handheld electronic device can further include a ROM, which stores the operating system for the handheld electronic device. Based on the content of the default value, the operating system is to, when the microprocessor is switched from the sleeping mode to the operating mode, retrieve screen data from the non-default code storage device, and to display the screen data onto the display device. The forementioned ROM may be a flash memory.

The above-mentioned handheld electronic device may further include a user interface provided for the user of the handheld electronic device, to set a default value. The user interface can search for the screen data stored in the non-default code storage device, and display a list of screen data for the user to select from. After the user has selected one of the screen data, the user interface set the content of the default value to the selected screen data.

When the microprocessor is switched from the sleeping mode to the operating mode, the operating system checks the default value, and according to the default value to retrieve the screen data from the non-default code storage device as the power on/off screen data. If the default value is not set to any screen data stored in the non-default code storage device, the power on/off screen data will not be displayed when the power is powered on or off.

### BRIEF DESCRIPTION OF THE DRAWINGS

FIG. 1 is a block diagram illustrating the structure of a conventional handheld electronic device.

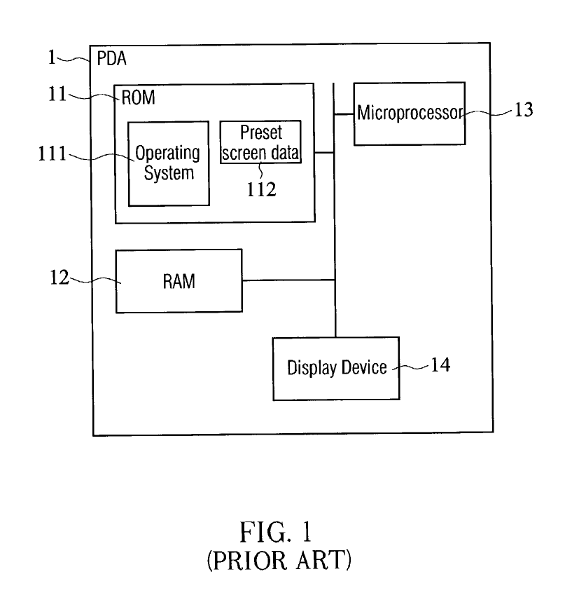

FIG. 2 is a block diagram illustrating the structure of another conventional handheld electronic device.

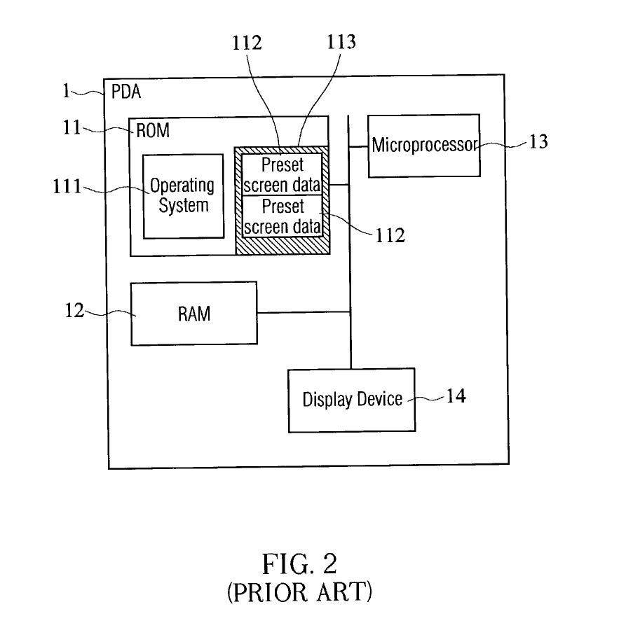

FIG. 3 is a block diagram illustrating the structure of a handheld electronic device in accordance with an embodiment of the invention.

FIG. 4 is a flow diagram illustrating steps of how the user interface sets the default value in the embodiment of the invention.

FIG. 5 is a flow diagram illustrating steps of how the operating system displays the power on/off screen when the device is powered on or warm reset in the embodiment of the invention.

FIG. 6 is a flow diagram illustrating steps of how the operating system displays the power on/off screen when the device is cold reset in the embodiment of the invention.

### DETAILED DESCRIPTION OF PREFERRED EMBODIMENTS

With reference to accompanying drawings, what follows are descriptions of a handheld electronic device with selections of power on/off screens in an embodiment of the invention and the implementation method, wherein same elements are denoted with the same referencing symbols for further explanations.

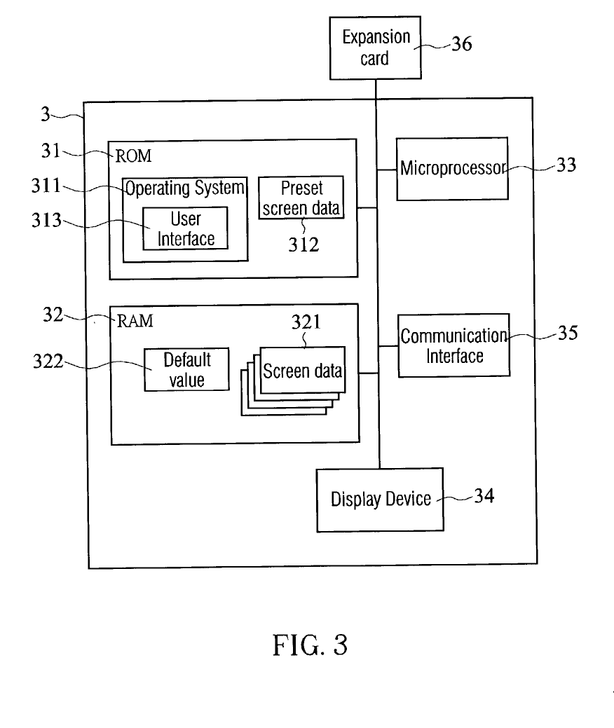

Referring to FIG. 3, in accordance with the embodiment of the invention, the handheld electronic device 3 includes a read only memory (ROM) 31, a random access memory (RAM) 32, a microprocessor 33, a display device 34 and a communication interface 35. Similar to the conventional technology, the ROM 31 stores an operating system 311 and a preset screen data 312 for the handheld electronic device 1, wherein the operating system 311 includes a user interface 313.

The RAM 32 is a non-default code storage device. It stores at least one screen data 321 and a default value 322. The RAM 32 can be internally built in the handheld electronic device 3, or be installed in an expansion card 36. The microprocessor 33 can be signally connected to the RAM 32 via a data address line, in order to access directly all data stored in the RAM 32, or through the memory controller to access data stored in the RAM 32. The screen data 321 stored in the RAM 32 can be received from the communication interface 35, or from direct editing on the handheld electronic device 3 by the user. The user sets a default value 322 via the user interface 313.

In a handheld electronic device 3, the communication interface 35 can be any wire or wireless transmission interface that is able to receive data, such as PCMCIA interface, RS-232 interface, infrared wireless transmission interface, or GSM communication interface, etc. The microprocessor 33 can be any central processing unit (CPU) used in handheld electronic devices. The display device 34 can be a liquid crystal display (LCD) panel or any displaying devices used on handheld electronic devices.

In this embodiment, the microprocessor 33 can be switched between a sleeping mode and an operating mode. When the microprocessor 33 is in the sleeping mode, it operates with extremely small amount of power consumption and maintains the data stored in the RAM 32 so that it will not be lost. The status of the handheld electronic device 3 is what generally called “power-off status”. When a user turns on or resets the handheld electronic device 3, the microprocessor 33 then executes to switch from the sleeping mode to the operating mode. At this time, the status of the handheld electronic device 3 is what generally called “power-on status”.

Because data stored in RAM 32 is not lost under the sleeping mode, the screen data 321 and the default value 322 therefore are stored even in the power-off status. For this reason, the screen data can be continuously stored in the handheld electronic device 3, and be used as the power on/off screen when the microprocessor 33 is switched from the sleeping mode to the operating mode.

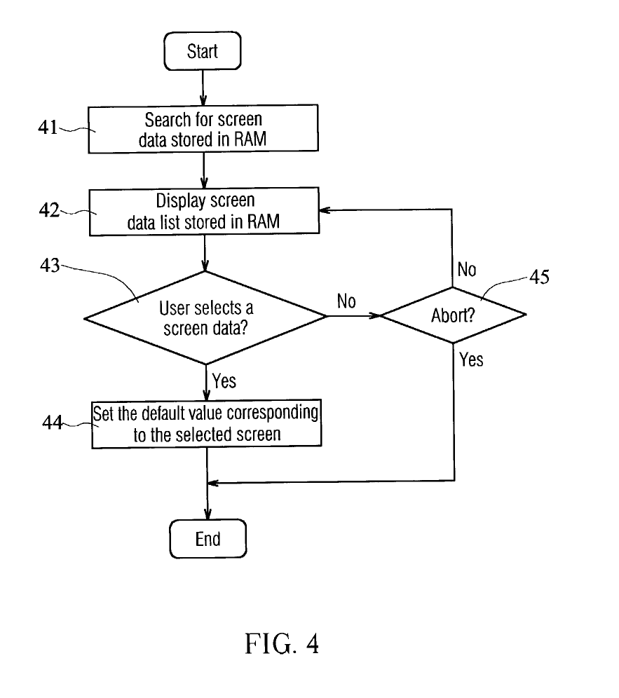

Referring to FIG. 4, when a user uses the user interface 313 in the operating system 311 to set the default value 322, the user interface 313 will first search RAM 32 for screen data 321 (Step 41). Note here that the user interface 313 can search for only a particular folder or the entire RAM 32 for data stored, in order to look for screen data 321.

After completing the search, the user interface 313 displays a list of screen data, and accepts a user selection of screen from the list (Step 42). If the user selects a screen data (Step 43), the user interface 313 then set the content of the default value 322 corresponding to the selected screen data. For instance, the user interface 313 can set the content of the default value 322 as the file path name of the selected screen data 321, or set it as the address of the memory. If the user did not select any screen data but to terminate the process (Step 45), it then terminates the process of default value setting.

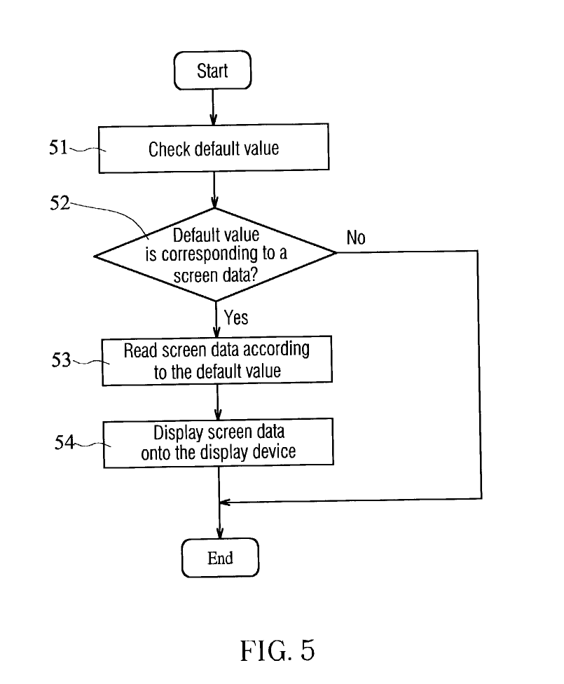

Referring to FIG. 5, when the handheld electronic device 3 is powered on or warm reset, the operating system 311 firstly checks the default value 322, to confirm the contents of the default value 322 (Step 51). If the default value 322 corresponds to the screen data 321 (Step 52), the operating system 311 then reads the corresponding screen data 321 from the RAM 32 based on the contents of the default value 322 (Step 53), and displays it onto the display device 34 as the power on/off screen (Step 54). If the default value 322 is not set to any screen data 321, the operating system 311 then will not display any power on/off screen.

When the display device 34 displays the power on/off screen, the operating system 311 can carry out tasks such as system initialization, hardware resources search, or data loading, etc. After the forementioned tasks have been completed, the operating system 311 then get into the user interface screen preparing to accept the command inputted by the user.

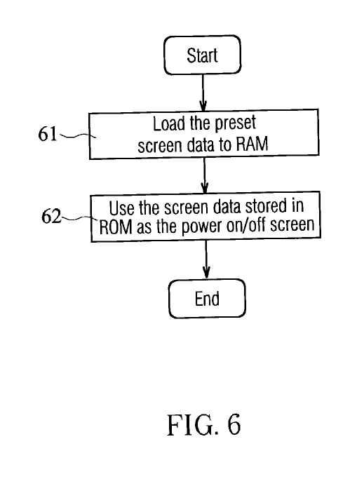

Referring to FIG. 6, when the handheld electronic device is switched from a status with completely no electric power (that is, the power is too low to maintain the sleeping mode status) to the operating mode, the operating system will proceed the procedure of cold reset. At this time, because the RAM 32 does not have any default value stored in it, nor does it store any screen data, the operating system therefore load the preset screen data 312 from the ROM 31 to the RAM 32 (Step 61), and then uses this screen data as the power on/off screen and displays it onto the display device (Step 62). Later, when the handheld electronic device is switched between the sleeping mode and the operating mode, the operating system will base on the default value recorded in RAM 32, use the screen data stored in the RAM 32 as the power on/off screen.

In the invention, because screen data are stored in a non-default code storage device such as a RAM, the handheld electronic device can store comparatively larger amount of screen data than conventional one, until there is no more storage space left in the RAM. When storing fewer amounts of screen data, the remaining storage space can also be used to store other information, thus comparing to the conventional device, the usage of the memory storage is more flexible. Furthermore, through a prior search of the default value for a power on/off screen, the handheld electronic device in the invention can select screen data stored in the RAM as the power on/off screen. Thereby, it satisfies user's need for personalizing the handheld electric device.

Note well that, those skilled in the art may make any modifications and changes to the foregoing specification without departing from the spirit and scope of the invention. For example, the forementioned default value may be stored at a fixed address in a read only memory instead of in a dynamic random access memory. When the microprocessor is switched from the sleeping mode to the operating mode, if the default value is not set to any screen data, the operating system can display the preset screen stored in the ROM, instead of not displaying any power on/off screen as described in the foregoing specification. Furthermore, the displaying and setting of the power on/off screen can be implemented in a specific chip, such as an application specific integrated circuit (ASIC).

For this, the foregoing specification is intended in all respects to be illustrative rather than restrictive. Any modifications and changes made thereto without departing from the spirit and scope of the invention should all be included in the appended claims.

What is claimed is:

1. A handheld electronic device with selections of power on/off screens, comprising:
a display device;
a non-default code storage device; and
a microprocessor, which can be switched between a sleeping mode and an operating mode; when the microprocessor is in the sleeping mode, the non-default code storage device does not lose data stored therein,
wherein the non-default code storage device stores at least one screen data, and when the microprocessor is switched from the sleeping mode to the operating mode, the handheld electronic device according to a default value reads the screen data from the non-default code storage device and displays the screen data onto the display device.

2. The handheld electronic device of claim 1, wherein the default value is stored in the non-default code storage device.

3. The handheld electronic device of claim 1, wherein the non-default code storage device is a random access memory (RAM).

4. The handheld electronic device of claim 1, further comprising:
a user interface, which is provided for a user to set the default value.

5. The handheld electronic device of claim 1, wherein the non-default code storage device is built in the handheld electronic device.

6. The handheld electronic device of claim 1, wherein the non-default code storage device is configured in an expansion card.

7. The handheld electronic device of claim 1,-further comprising:
a read only memory (ROM), which stores the operating system for the handheld electronic device, such that when the microprocessor is switched from the sleeping mode to the operating mode, the handheld electronic device is operated by the operating system reading the screen data from the non-default code storage device according to the default value, and then displaying the screen data onto the display device.

8. The handheld electronic device of claim 7, wherein the ROM comprises flash memory.

9. The handheld electronic device of claim 7, wherein the ROM further stores a preset screen data.

10. The handheld electronic device of claim 7, wherein the operating system comprises a user interface, which is provided to a user to set the default value.

11. The handheld electronic device of claim 1, further comprising:
a communication interface to receive the screen data.

12. A method for implementing selections of power on/off screens for a handheld electronic device, wherein the handheld electronic device comprises a display device, a non-default code storage device and a microprocessor, and the microprocessor can be switched between a sleeping mode and an operating mode, and when the microprocessor is in the sleeping mode, the non-default code storage device does not lose data stored therein, the method comprising:
checking for a default value when the microprocessor is switched from the sleeping mode to the operating mode;
reading a screen data from the non-default code storage device according to the default value; and
displaying the screen data onto the display device.

13. The method of claim 12, further comprising:
providing a user interface for the user, which receives the screen data corresponding to the default value set by the user through the user interface.

14. The method of claim 12, further comprising:
when the default value is not corresponding to any screen data, no screen data will be displayed on the display device.

15. The method of claim 12, further comprising:
when the handheld electronic device is cold reset, load a preset screen data from a ROM to the non-default code storage device, and display the preset screen data onto the display device.

16. A method for implementing selections for power on/off screens for a handheld electronic device, wherein the handheld electronic device comprises a non-default code storage device, the method comprising:
searching for screen data stored in the non-default code storage device;
displaying a list of screen data;
accepting screen data selected from the list by the user; and
setting a default value corresponding to the selected screen data.

17. The method of claim 16, wherein the handheld electronic device further comprises a microprocessor and a display device, the microprocessor can be switched between a sleeping mode and an operating mode, and the method further comprising:
checking for the default value when the microprocessor is switched from the sleeping mode to the operating mode;
reading the screen data from the non-default code storage device according to the default value; and
displaying the screen data onto the display device.

18. The method of claim 16, further comprising:
when the default value is not corresponding to any screen data, no screen data will be displayed on the display device.

19. A recording medium, readable by a handheld electronic device, which stores execution codes for the following procedures executable by a handheld electronic device once the codes are loaded:
checking for a default value when a microprocessor of the handheld electronic device is switched from a sleeping mode to an operating mode;
reading a screen data from a non-default code storage device of the handheld electronic device according to the default value; and
displaying the screen data onto a display device of the handheld electronic device.

20. The recording medium of claim 19, wherein the procedure further comprises:
providing a user interface for the user, which receives the screen data corresponding to the default value set by the user through the user interface.

21. The recording medium of claim 19, wherein the procedure further comprises:
when the default value is not corresponding to any screen data, no screen data will be displayed on the display device.

22. The recording medium of claim 19, wherein the procedure further comprising:
when the handheld electronic device is cold reset, load a preset screen data from a ROM to the non-default code storage device, and display the preset screen data onto the display device.

23. The recording medium of claim 19, wherein the procedure further comprising:
searching for screen data stored on the non-default code storage device;
displaying a list of screen data;
accepting screen data selected from the list by the user; and
setting a default value corresponding to the selected screen data.
